(19) United States
(12) Patent Application Publication
(10) Pub. No.: US 2019/0024849 A1
(43) Pub. Date: Jan. 24, 2019

(54) CONTROL DEVICE, CONTROL SYSTEM, CONTROL METHOD, AND NON-TRANSITORY COMPUTER-READABLE RECORDING MEDIUM

(71) Applicant: NEC Corporation, Minato-ku, Tokyo (JP)

(72) Inventor: Jun SAKAI, Tokyo (JP)

(73) Assignee: NEC Corporation, Minato-ku, Tokyo (JP)

(21) Appl. No.: 16/072,251

(22) PCT Filed: Feb. 14, 2017
(86) PCT No.: PCT/JP2017/005220

§ 371 Date: Jul. 24, 2018

(30) Foreign Application Priority Data
Feb. 19, 2016 (JP) 2016-030138

(51) Int. Cl. F17D 5/06; F17D 1/20; F17D 1/14; E03B 7/07

(52) U.S. Cl. CPC F17D 5/06; F17D 1/20; E03B 7/02; E03B 7/075; F17D 1/14

(57) ABSTRACT

Provided is a control device, etc., with which it is possible to increase the accuracy of control of a pump, valve, etc., provided to a pipeline network. This control device is provided with: a friction loss calculation unit for determining pressure friction loss on the basis of the pressure of a fluid in piping; a control amount calculation unit for determining, on the basis of the friction loss, a control amount of the pump or valve that controls the distribution of water in the piping; and a control unit for controlling the pump or valve on the basis of the control amount.

### TECHNICAL FIELD

The present invention relates to a control device, a control system, a control method, and a computer-readable recording medium.

### BACKGROUND ART

In a water distribution network system that distributes clean water to a consumer who uses water from a water purification plant, a pump or a valve or the like is controlled in such a way that a proper water pressure will be maintained even at an end of a water distribution network. On the other hand, it is preferable, for example, to reduce a discharge pressure and the number of operating pumps in order to suppress energy consumption of a pump. When reducing the discharge pressure of a pump, it is necessary to estimate a friction loss of piping with high accuracy in such a way that a proper water pressure will be maintained.

PTL 1 describes a design method for a fluid transfer system or the like. The system described in PTL 1 performs steps including: a step of inputting a design condition; a step of calculating a pipe friction coefficient; a step of calculating a pressure loss of a single channel; and a step of summing the results of calculation about the single channel.

PTL 2 describes a water distribution control system. The water distribution control system described in PTL 2 simulates the state of a water distribution network by using real-time process data, and automatically calculates and sets an optimum operation variable to an operation point such as a water filling point.

PTL 3 describes a water distribution pressure control system. The system described in PTL 2 controls a water distribution pressure in such a way that an end pressure will be maintained above a target value even in the worst case, based on a pipeline resistance model considering a modeling error. Further, the system described in PTL 3 determines, without delay, an unexpected demand out of an ordinary demand pattern of a fire hydrant flow rate or the like by measuring the unexpected demand by using a flow rate sensor, and controls a water distribution pressure with high accuracy by calculating a target discharge pressure at a shorter cycle than usual.

### CITATION LIST

### Patent Literature

### [PTL 1] Japanese Patent Application Publication No. 2001-165399

### [PTL 2] Japanese Patent Application Publication No. 2006-104777

### [PTL 3] Japanese Patent Application Publication No. 2012-193585

### SUMMARY OF INVENTION

### Technical Problem

With a technique described in PTL 1 or PTL 2, a pressure loss or the like is determined based on a value or the like previously stored on a database of a system. With a technique described in PTL 3, a pipeline resistance is determined for an entire water distribution network. In other words, a technique described in any one of PTL 1 through PTL 3 does not necessarily consider estimation of a friction loss of piping with high accuracy. As a result, it is difficult for the technique described in any one of PTL 1 through PTL 3 to increase the accuracy of control of a pump or a valve or the like arranged in a pipeline network.

The invention has been created for the purpose of solving the above problems and aims mainly to provide a control device or the like capable of increasing the accuracy of control of a pump or a valve arranged in a pipeline network.

### Solution to Problem

According to an aspect of the present invention is a control device. The control device includes friction loss calculation means for determining, based on a pressure of a fluid in piping, a friction loss of the pressure; controlled variable calculation means for determining, based on the friction loss, a controlled variable of a pump or a valve that controls the distribution of water in the piping; and control means for controlling the pump or the valve, based on the controlled variable.

According to an aspect of the present invention is a control system. The control system includes pressure acquisition means for acquiring a pressure in the piping at a plurality of points of the piping; and the control device for determining a controlled variable of the pump or the valve by using the pressure and controlling the pump or the valve.

According to an aspect of the present invention is a control method. The control method is for determining, based on a pressure of a fluid in piping, a friction loss of the pressure, determining, based on the friction loss, a controlled variable of a pump or a valve that controls the distribution of water in the piping, and controlling the pump or the valve, based on the controlled variable.

According to an aspect of the present invention is a computer-readable recording medium. The computer-readable recording medium stores a program for executing on a computer causing the computer to execute; processing to determine, based on a pressure of a fluid in piping, a friction loss of the pressure; processing to determine, based on the friction loss, a controlled variable of a pump or a valve that controls the distribution of water in the piping; and processing to control the pump or the valve, based on the controlled variable.

### Advantageous Effects of Invention

According to the invention, it is possible to provide a control device or the like capable of increasing the accuracy of control of a pump or a valve or the like arranged in a pipeline network.

### BRIEF DESCRIPTION OF DRAWINGS

FIG. 1 illustrates a configuration of a control device according to a first example embodiment of the invention.

FIG. 2 illustrates an example case where the control device according to the first example embodiment of the invention is applied to a pipeline network of a water supply.

FIG. 3 is a flowchart illustrating the operation of the control device according to the first example embodiment of the invention.

FIG. 4 illustrates a configuration of a control device according to a variation of the first example embodiment of the invention.

FIG. 5 illustrates a configuration of a controlled variable calculation device according to the variation of the first example embodiment of the invention.

FIG. 6 illustrates a configuration of a friction loss calculation device according to the variation of the first example embodiment of the invention.

FIG. 7 illustrates an example of an information processing device that embodies a control device or the like according to an example embodiment of the invention.

### EXAMPLE EMBODIMENT

An example embodiment of the invention will be described referring to attached drawings. In an example embodiment of the invention, a component of a device or a system indicates a functional unit block. A part or a whole of the component of the device or the system is embodied, for example, by any combination of an information processing device 1000 and a program illustrated in FIG. 7. The information processing device 1000 includes an example configuration described below:

### Central Processing Unit (CPU) 1001

### Read Only Memory (ROM) 1002

### Random Access Memory (RAM) 1003

Program 1004 loaded to RAM 1003
Storage device 1005 that stores the program 1004
Drive device 1007 that reads/writes from/to a recording medium 1006
Communication interface 1008 that connects to a communication network 1009
Input/Output interface 1010 that performs data input/output
Bus 1011 that interconnects components

A component of a device in an example embodiment is embodied when the CPU 1001 acquires and executes the program 1004 that achieves the above functions. The program 1004 that achieves the functions of a component of a device is stored previously, for example, on the storage device 1005 or RAM 1003 and read by the CPU 1001 as appropriate. The program 1004 may be supplied to the CPU 1001 via the communication network 1009 or stored previously on the recording medium 1006 and the drive device 1007 may read and supply the program to the CPU 1001.

A device may be embodied by way of a variety of variations. For example, a device may be embodied, for each component, by any combination of a separate information processing device 1000 and a program. A plurality of components of a device may be embodied by any combination of a single information processing device 1000 and a program.

A part or a whole of a component of a device is embodied by general-purpose or special-purpose circuitry, a processor or the like, or a combination thereof. The component may consist of a single chip or a plurality of chips interconnected via a bus. A part or a whole of a component of a device may be embodied by a combination of the circuitry or the like and the program mentioned above.

When a part or a whole of a component of a device is embodied by a plurality of information processing devices or circuits or the like, the plurality of information processing devices or circuits or the like may be centralized or dispersed. For example, the information processing devices or circuits or the like may be embodied by a client server system, a cloud computing system or any other configuration where an information processing device or a circuit is interconnected via a communication network.

In the following description of a control device or the like according to an example embodiment of the invention, the control device controls a water supply network that supplies clean water or a facility arranged in the water supply network. Note that the target of control by the control device according to an example embodiment of the invention is not limited to a water supply network.

### First Example Embodiment

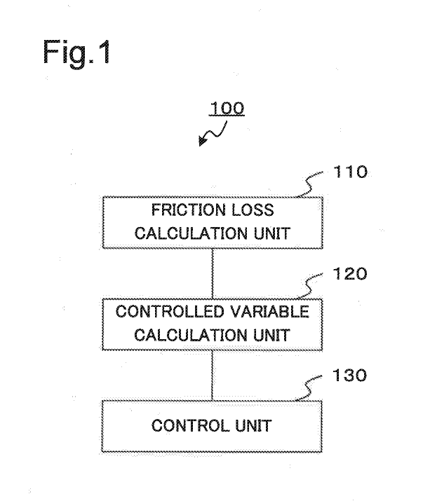

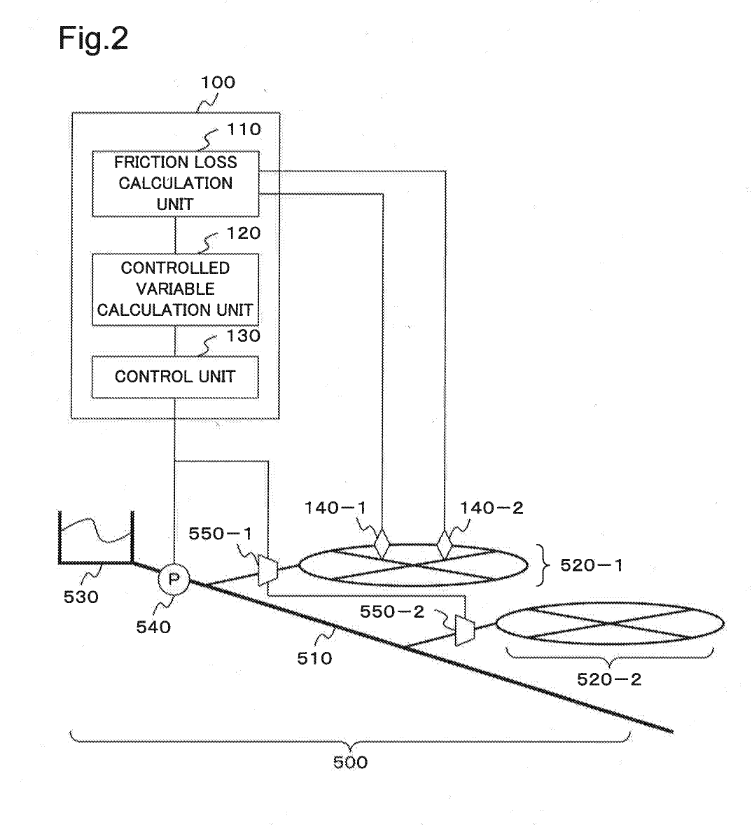

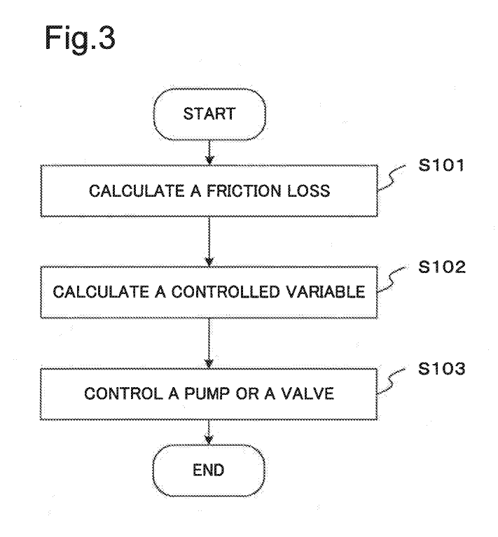

A first example embodiment of the invention will be described below. FIG. 1 illustrates a configuration of a control device according to the first example embodiment of the invention. FIG. 2 illustrates an example case where the control device according to the first example embodiment of the invention is applied to a water supply network. FIG. 3 is a flowchart illustrating the operation of the control device according to the first example embodiment of the invention.

As illustrated in FIG. 1, a control device 100 according to the first example embodiment of the invention includes a friction loss calculation unit 110, a controlled variable calculation unit 120, and a control unit 130. The friction loss calculation unit 110 determines a friction loss of a pressure of a fluid in piping, based on the pressure of the fluid in the piping. The controlled variable calculation unit 120 determines a controlled variable of a pump or a valve that controls water distribution, based on the friction loss determined by the friction loss calculation unit 110. The control unit 130 controls a pump or a valve, based on the control volume determined by the controlled variable calculation unit 120. FIG. 2 is an example where the control device 100 according to this example embodiment is applied to a pipeline network 500 as a water supply network. Note that, in the following description, a “pressure of a fluid in piping” may be referred to as a “pressure in piping”. A “friction loss of a pressure of a fluid in piping” may be referred to as a “friction loss of a pressure” or a “friction loss of piping”.

The pipeline network 500 illustrated in FIG. 2 is a water supply network and consists mainly of a water main 510 and one or a plurality of water distribution blocks 520. In the example of the pipeline network 500 illustrated in FIG. 2, two water distribution blocks 520, a water distribution block 520-1 and a water distribution block 520-2, are connected to the water main 510. The water main 510 consists of a plurality of pipes.

The water main 510 supplies clean water acquired through purification by the water purification plant 530 to a water distribution block 520. The water main 510 may be equipped with a pump 540. The water distribution block 520 supplies clean water as a fluid distributed from the water purification plant 530 via the water main 510 to a consumer who uses water. The water distribution block 520 consists of a plurality of pipes.

A point where the water main 510 connects to the water distribution block 520 may be equipped with a valve 550. The valve 550 regulates the pressure of clean water in such a way that a water pressure or a pressure of clean water flowing through the water distribution block 520 will be maintained at a proper level. In the example illustrated in FIG. 2, a point where the water main 510 connects to the water distribution block 520-1 is equipped with a valve 550-1. A point where the water main 510 connects to the water distribution block 520-2 is equipped with a valve 550-2. Further, a water distribution block 520 may be equipped with a pump 540 or a valve 550 (not illustrated).

Piping that constitutes the water distribution block 520 is equipped with a pressure sensor 140. In the example illustrated in FIG. 2, the water distribution block 520-1 is equipped with a pressure sensor 140-1 and a pressure sensor 140-2. The pressure sensor 140 is mounted on a fire hydrant or the like in the pipeline network 500. The pressure sensor 140 measures a water pressure as a pressure of water flowing in piping and a temporal change in water pressure. Information regarding the water pressure measured by the pressure sensor 140 is used when the control device 100 determines a friction loss of piping or the like as mentioned later. The information regarding the pressure measured by the pressure sensor 140 is stored, as appropriate, on a database or a storage device or the like (not illustrated). In this example embodiment, the pressure sensor 140 is not limited in type or in structure but a pressure sensor 140 of any type or structure may be used. Note that the pressure sensor 140 preferably measures a pressure at a cycle that permits analysis mentioned later. As an example, the pressure sensor 140 preferably measures a pressure at a cycle of 100 or more samples per second.

A point equipped with the pressure sensor 140 is not limited to the example illustrated in FIG. 2. In other words, any number of pressure sensors 140 may be arranged, as appropriate, in the water distribution block 520. A pressure sensor 140 may be arranged on the water main 510 in such a way that a water pressure in the water main 510 and a temporal change in the water pressure will be measured.

Next, a component of the control device 100 according to the first example embodiment of the invention will be described.

A friction loss calculation unit 110 determines a friction loss of a pressure of a fluid in piping, based on the pressure of water or the like in the piping. The friction loss of the pressure of the fluid in the piping represents a degree of a decrease in the pressure of water or the like caused by friction with an inner wall surface of the piping observed when water or the like flows in the piping. More particularly, the friction loss calculation unit 110 determines a friction loss of a pressure of a fluid in piping, based on a transient change in the pressure of the fluid such as water in the piping. Note that, in an example embodiment, the transient change in the pressure of the fluid such as water in the piping represents a sudden change in the pressure. The transient change in the pressure of the fluid such as water in the piping is also called a water hammer. A pressure of a fluid such as water in piping and a transient change in the pressure thereof are determined, for example, by using information regarding a pressure value measured by two pressure sensors, that is, pressure sensors 140-1 and 140-2 illustrated in FIG. 2. Note that the friction loss calculation unit 110 determines a friction loss of piping between points where two pressure sensors separately measure a water pressure. In the example illustrated in FIG. 2, the friction loss calculation unit 110 determines a friction loss of piping between points where the pressure sensor 140-1 or 140-2 measures a water pressure. Note that, when another pressure sensor 140 (not illustrated) is arranged in the pipeline network 500, the friction loss calculation unit 110 may determine a friction loss of piping at a point where the other pressure sensor 140 is arranged.

The water distribution block 520 or the like in the pipeline network 500 may be subjected to sudden opening/closing of the valve 550, occurrence or collapse of an airlock in water in piping, for example in water flowing in piping, or sudden opening/closing of a tap that accompanies the use of water by a consumer who uses water. This will cause a sudden change in the pressure of water in piping that constitutes the water distribution block 520. This change is also called a water hammer as mentioned above. The water hammer may result from operation of a pump 540, a valve 550 or a fire hydrant (not illustrated) or the like arranged at some points of the pipeline network 500. The water hammer propagates through water in piping.

The friction loss calculation unit 110 determines a friction loss of piping, based on a transient change in water pressure observed when the pressure sensor 140-1 or 140-2 measures a single water hammer that has propagated through water in the piping.

As an example, the friction loss calculation unit 110 determines a friction loss of a pressure of a fluid in piping as described below. The friction loss calculation unit 110 determines a friction loss of a pressure of a fluid in piping by using the water pressure measured by the pressure sensor 140-1 or 140-2, based on a friction coefficient of the piping. A change in water pressure observed when a water hammer has occurred is represented by a motion equation of a water hammer indicated by Equation 1 given below and an equation of continuity of water indicated by Equation 2 given below. Note that the state of a water flow in piping is assumed as a turbulence in this example.

In Equation 1 and Equation 2, g represents an acceleration of gravity, A a cross-sectional area of piping, q a flow rate of water flowing in piping, t a time, h a pressure of water in piping represented by a water head, λ a friction coefficient of piping, D the diameter of a distribution pipe, and a a propagation speed of a water hammer in piping. x represents a distance of piping in the longitudinal direction over which a friction loss is to be determined. Note that h is a dimension of length.

$$[ Math 1 ]$$

$$\begin{matrix}\frac{1}{gA} \frac{\partial q}{\partial t} + \frac{\partial h}{\partial x} + \frac{λ}{2 {gDA}^{2}} q \vert q \vert = 0 \\ [ Math 2 ] & ( 1 ) \\ \frac{gA}{{a}^{2}} \frac{\partial h}{\partial t} + \frac{\partial q}{\partial x} = 0 & ( 2 )\end{matrix}$$

When Equation 1 and Equation 2 are satisfied simultaneously, the water pressure h is represented by Equation 3 given below. Equation 3 represents a water hammer as a wave motion. Note that, in Equation 3, γ represents a propagation constant, e a base of natural logarithm, j an imaginary unit, and w an angular frequency of a water hammer.

$$[ Math 3 ]$$

$$h = {K}_{0} {e}^{- γ x} + {K}_{1} {e}^{γ x} \\ wherein γ = \sqrt{\frac{j ω}{{a}^{2}} ( \frac{λ q}{DA} + j ω )} , {K}_{0} , {K}_{1} is constant \qquad ( 3 )$$

Note that γ represents a propagation constant. The propagation constant γ indicates a degree of attenuation or delay, depending on a distance, of a propagation waveform that propagates through water in piping. Assuming that α and β are real numbers and γ=α+jβ in Equation 3, the friction coefficient is represented by Equation 4. α represents an attenuation factor of a water hammer. The attenuation factor α has a frequency characteristic represented by ω. In other words, the friction coefficient is determined based on a speed of sound and an amplitude attenuation observed when a water hammer propagates through water. β is a function of a propagation speed of a water hammer.

$$[ Math 4 ]$$

$$λ = \frac{2 a α DA}{q} \sqrt{1 + {( a α \text{/} ω )}^{2}} \qquad ( 4 )$$

A time waveform of a water hammer measured by respective pressure sensors 140-1 and 140-2 are represented by H₁, H₂ and the corresponding fluctuations h₁, h₂. h₁ and h₂ indicate a difference between the water pressure measured by the pressure sensor 140-1 or 140-2 when a water hammer has occurred and a pressure that may be measured when water regularly flows in piping. In this case, the aforementioned propagation constant γ is represented by Equation 5 given below. In Equation 5, L represents a distance between points where the pressure sensor 140-1 or 140-2 measures a water pressure.

$$[ Math 5 ]$$

$$γ = - \frac{{log}_{e} ( {h}_{2} \text{/} {h}_{1} )}{L} \qquad ( 5 )$$

As mentioned above, h₁ and h₂ are determined based on measurement values determined by respective pressure sensors 140-1 and 140-2. L is determined depending on a position on piping where the pressure sensor 140-1 or 140-2 measures a pressure. Thus, a propagation constant γ is determined based on a ratio between fluctuations in water pressure as a measurement value determined by the pressure sensor 140-1 or 140-2.

α represents a real part of γ as mentioned above. In other words, a is represented by α=Re[γ]. α and ω included in Equation 4 are determined based on Equation 5. In Equation 4, a that represents the propagation speed of a water hammer in piping is determined based on, for example, a difference in measurement time of day observed when the same water hammer is measured by the pressure sensor 140-1 or 140-2. a that represents the propagation speed of a water hammer may be theoretically determined based on a characteristic or the like including a material of piping or the diameter thereof.

Thus, a product of a friction coefficient λ and a flow rate q may be determined based on the measurement value or the like determined by the pressure sensor 140-1 or 140-2. In other words, the friction loss calculation unit 110 may determine a product of a piping friction coefficient λ and a flow rate q by using Equations 4 and 5, based on the measurement value determined by the pressure sensor 140-1 or 140-2.

The pressure sensor 140-1 or 140-2 may measure a plurality of water hammers. The friction loss calculation unit 110 is capable of determining a product of a piping friction coefficient λ and a flow rate q regarding a waveform by using one of the waveforms representing a plurality of water hammers measured by the pressure sensor 140-1 or 140-2. The product of the friction coefficient λ and the flow rate q thus determined may vary as a result of a difference in frequency component, waveform or amplitude or the like, or measurement error between a plurality of water hammers. As mentioned above, Equation 4 includes ω and a as functions of frequency. Thus, when the friction loss calculation unit 110 determines a product of a piping friction coefficient λ and a flow rate q, based on Equation 4 and Equation 5, λ may vary depending on a frequency component of a water hammer or the like.

Thus, the friction loss calculation unit 110 may correct the aforementioned measurement variations or frequency fluctuations assuming the friction coefficient of a regular flow as λ_{eff}. A product of a friction coefficient λ_{eff} and a flow rate q of a regular flow that have undergone correction is represented by Equation 6 given below. In Equation 6, C₁ or C₂ represents a correction factor.

[Math 6]

|λ_{eff}q=C₁λq+C₂ (6)

Note that λ_{eff} or a product of λ_{eff} and q may be determined by using an equation different from Equation 6 mentioned above. Alternatively, uncorrected λ may be used depending on the status of piping or a water hammer. While λ_{eff} is used in the following description, λ may be used instead of λ_{eff}.

When a product of λ_{eff} and q is determined, a flow rate q of a regular flow is determined by using the Darcy-Weisbach equation illustrated in Equation 7 given below, based on h₁ and h₂ as fluctuations in pressure. In Equation 7, Δh represents a degree of a decrease in the pressure of water between points where the pressure sensor 140-1 or 140-2 measures a water pressure. In other words, Equation 7 indicates a relationship between a difference in the pressure of water or the like in a pipeline or piping between two points and a flow rate at the two points.

$$[ Math 7 ]$$

$$Δ h = {h}_{1} - {h}_{2} = \frac{{λ}_{eff} L}{2 {gDA}^{2}} q \vert q \vert \qquad ( 7 )$$

In Equation 7, the friction coefficient λ or λ_{eff} depends on a flow rate. In other words, these values may vary as a result of a change in a flow rate of water in piping. Thus, Hazen-Williams coefficient C indicated in Equation 8 given below is determined by using the aforementioned h₁ and h₂ determined by respective pressure sensors 140-1 and 140-2 and the flow rate q determined by Equation 7. Equation 8 indicates a relationship between a difference in pressure and a flow rate regarding water in a pipeline at two points. In Equation 8, C is an example friction coefficient that does not depend on the flow rate of water. Further, C is a coefficient representing the smallness of a friction loss.

[Math 8]

|Δh=10.666C^{-1.852}D^{-4.871}Lq^{1.852} (8)

The relationship between a pressure and a flow rate is determined by using the coefficient C determined by Equation 8, based on the water pressure measured by the pressure sensor 140-1 or 140-2 for any flow rate. In other words, the friction loss calculation unit 110 is capable of determining the relationship between a pressure and a flow rate in a region between the pressure sensors 140-1 and 140-2 on piping and at surrounding points thereof, based on the water pressure measured by the pressure sensor 140-1 or 140-2. Thus, the friction loss calculation unit 110 is capable of determining a friction loss in a region between the pressure sensors 140-1 and 140-2 on piping and at surrounding points thereof.

The friction loss calculation unit 110 may construct a piping model, based on, for example, the friction loss determined as mentioned above. The piping model represents a friction loss at a point of the pipeline network 500. In other words, the friction loss calculation unit 110 constructs a piping model by determining the aforementioned Hazen-Williams coefficient C, based on the pressure determined by the pressure sensor 140 at some points of the pipeline network 500. The friction loss calculation unit 110 then determines a relationship between a pressure of water or the like and a flow rate at a desired point of the pipeline network 500, based on the piping model and the pressure determined by the pressure sensor 140.

The controlled variable calculation unit 120 determines a controlled variable of a pump 540 or a valve 550 that controls water distribution, based on the friction loss of the pressure of the fluid in the piping determined by the friction loss calculation unit 110. In the aforementioned example, the controlled variable calculation unit 120 determines the controlled variable of the pump 540 or valve 550, based on the relationship between the pressure of water or the like and the flow rate in the piping determined by using C of Equation 8.

The controlled variable calculation unit 120 determines the controlled variable of the pump 540 or valve 550 in such a way that a predetermined condition regarding a water pressure will be satisfied at a point of the pipeline network 500. The predetermined condition regarding the water pressure may be determined as a specific standard value, for example, 40 mH₂O (meter water column). Alternatively, the standard value may be determined as a condition, for example, a “water pressure capable of supplying water up to a height corresponding to the third floor of a building without using a pump”.

As an example, the controlled variable calculation unit 120 may determine a controlled variable as described below. When C of Equation 8 is determined by the friction loss calculation unit 110, a difference in water pressure between any two points of the pipeline network 500 is determined. In other words, a water pressure is determined by using Equation 8 at a point where the pump 540 or the like is arranged, assuming that any point of the pipeline network 500 satisfies the aforementioned condition regarding a water pressure. In other words, a water pressure at any point satisfies the aforementioned condition when the pump 540 or valve 550 or the like is controlled in such a way that the water pressure at a point where the pump 540 or the like is arranged will reach the aforementioned water pressure.

The controlled variable calculation unit 120 calculates the controlled variable of a specific pump 540 or valve 550 or the like as described below. When a relationship between a water pressure and a controlled variable of the pump 540 or the like is predetermined, the controlled variable calculation unit 120 determines a controlled variable, based on the relationship. For example, the controlled variable calculation unit 120 determines, as a controlled variable, the number of operating pumps 540 or the like, number of rotations thereof or opening of the valve 550 or the like relating to the aforementioned water pressure in the relationship.

Alternatively, the controlled variable calculation unit 120 may determine, while controlling the pump 540 or valve 550 or the like, a controlled variable by measuring the water pressure at a point where the pump 540 or valve 550 is arranged and checking whether the aforementioned water pressure is acquired. In other words, the controlled variable calculation unit 120 may determine a controlled variable by repeating control of the pump 540 or valve 550 or the like and measurement of the water pressure until the water pressure at a point where the pump 540 or the like is arranged reaches the aforementioned water pressure.

The controlled variable calculation unit 120 determines a controlled variable as mentioned above, which acquires a controlled variable of the pump 540 or valve 550 that will maintain a proper water pressure. It is thus possible to avoid a problem caused by an increase in water pressure above a necessary level. For example, it is possible to prevent the number of operating pumps 540 from being specified in excess of the necessary number, or it is possible to reduce the energy consumption. Water pressure is maintained at a proper level, which reduces a load on piping.

Further, the controlled variable calculation unit 120 determines a controlled variable in such a way that a proper water pressure will be maintained in the pipeline network. It is thus possible to avoid a problem caused by a decrease in water pressure below a necessary level. For example, it is possible to supply water at a proper water pressure even at an end of the water distribution block 520 in the pipeline network 500.

When it is necessary to determine a controlled variable of a plurality of pumps 540 or valves 550, the controlled variable calculation unit 120 may determine a controlled variable of the pumps 540 or valves 550 in various ways. For example, when a plurality of pumps 540 or valves 550 are arranged in the pipeline network 500, the controlled variable calculation unit 120 may determine a controlled variable of some or all of the plurality of pumps 540 or valves 550. The controlled variable calculation unit 120 may determine a controlled variable of both of the pumps 540 and valves 550, or either the pumps 540 or valves 550.

The controlled variable calculation unit 120 may maintain a proper water pressure by determining a controlled variable of the pump 540, based on a predetermined value or the like, and determining a controlled variable of the valve 550. Alternatively, the controlled variable calculation unit 120 may maintain a proper water pressure by determining a controlled variable of the valve 550, based on a predetermined value or the like, and determining a controlled variable of the pump 540.

Further, the controlled variable calculation unit 120 may determine a controlled variable of the pump 540 or valve 550 in such a way that a condition regarding a water pressure and any other condition will be satisfied. For example, the controlled variable calculation unit 120 may determine a controlled variable of the pump 540 or valve 550 in such a way that a controlled variable of the pump 540 or valve 550 will be reduced. Alternatively, the controlled variable calculation unit 120 may determine a controlled variable of the pump 540 or valve 550 in such a way that a condition regarding a water pressure will be satisfied and electric power necessary for operation of the pump 540 or control of the valve 550 will be reduced.

Further, the controlled variable calculation unit 120 may determine a controlled variable of the pump 540 or valve 550 as well as a facility or the like necessary for maintaining, for example, a water pressure in the pipeline network 500.

The control unit 130 controls the pump 540 or valve 550, based on the controlled variable determined by the controlled variable calculation unit 120. In other words, for example, the control unit 130 performs control necessary for changing the operating status of the pump 540 including the number of operating pumps 540 or operation speed, or opening of the valve 550. Note that the control unit 130 may control the pump 540 or valve 550 as well as a facility or the like necessary for maintaining, for example, a water pressure in the pipeline network 500.

The control unit 130 may control either the pump 540 or valve 550, or both the pump 540 and valve 550. When a plurality of pumps 540 or valves 550 are arranged in the pipeline network 500, the control unit 130 may control some or all of the plurality of pumps 540 or valves 550. In the example illustrated in FIG. 2, when the controlled variable calculation unit 120 has determined a controlled variable of the valve 550-1, based on the water pressure measured by the pressure sensor 140-1 or 140-2, the control unit 130 controls the valve 550-1, based on the controlled variable.

The control unit 130 controls a facility to be controlled including the pump 540 or valve 550 by transmitting a signal for controlling operation to the facility to be controlled via a control signal line or a communication network or the like. When the target facility is controlled by an operator, the control unit 130 may control operation of the pump 540 or valve 550 by notifying the operator of information or the like necessary for controlling the pump 540 or valve 550 or the like. In other words, the control unit 130 may be a mechanism that notifies, for example, the operator of the pipeline network 500 of a controlled variable of a facility to be controlled including the pump 540. In this case, the pump 540 or valve 550 is controlled by the operator, based on the operation variable sent from the control unit 130.

Next, operation of the control device 100 according to the first example embodiment will be described by using a flowchart illustrated in FIG. 3.

First, the friction loss calculation unit 110 determines a friction loss of a pressure of a fluid in piping, based on the pressure of water or the like in the piping determined by the pressure sensor 140-1 or 140-2 (step S101).

Next, the controlled variable calculation unit 120 determines a controlled variable of a pump or a valve, based on the friction loss determined in step S101 (step S102). As mentioned above, the controlled variable calculation unit 120 determines a controlled variable in such a way that a pressure of water or the like in piping will exceed a predetermined standard value.

Next, the control unit 130 controls a pump 540 or a valve 550 arranged in the pipeline network 500, based on the control volume determined in step S102 (step S103).

Note that the control device 100 may repeat the processing in steps S101 through S103 in such a way, for example, that a pressure of water or the like in piping will continuously exceed a predetermined standard value. In this case, the control device 100 may, for example, repeat the processing in steps S101 through S103 at predetermined intervals. The control device 100 may change the intervals for repeating the processing depending on a demand for water in the pipeline network 500. For example, the control device 100 may repeat the processing in steps S101 through S103 at shorter intervals than predetermined intervals during a time zone having a high demand for water. Or, the control device 100 may repeat the processing in steps S101 through S103 at longer intervals than predetermined intervals during a time zone having a low demand for water.

As mentioned above, in the control device 100 according to the first example embodiment of the invention, the friction loss calculation unit 110 determines a friction loss of a pressure of a fluid in piping. The controlled variable calculation unit 120 then determines a controlled variable of a pump or a valve, based on the friction loss determined, in such a way that a proper water pressure will be maintained in the pipeline network 500. Based on the controlled variable thus determined, a pump or a valve arranged in the pipeline network 500 is controlled by the control unit 130.

In other words, a pump or a valve arranged in the pipeline network 500 is controlled in such a way that a fluid such as water flowing in the pipeline network 500 will be maintained at a proper pressure. Thus, the control device 100 according to this example embodiment is capable of increasing the accuracy of control of a pump or a valve or the like arranged in a pipeline network.

### (Variation of the First Example Embodiment)

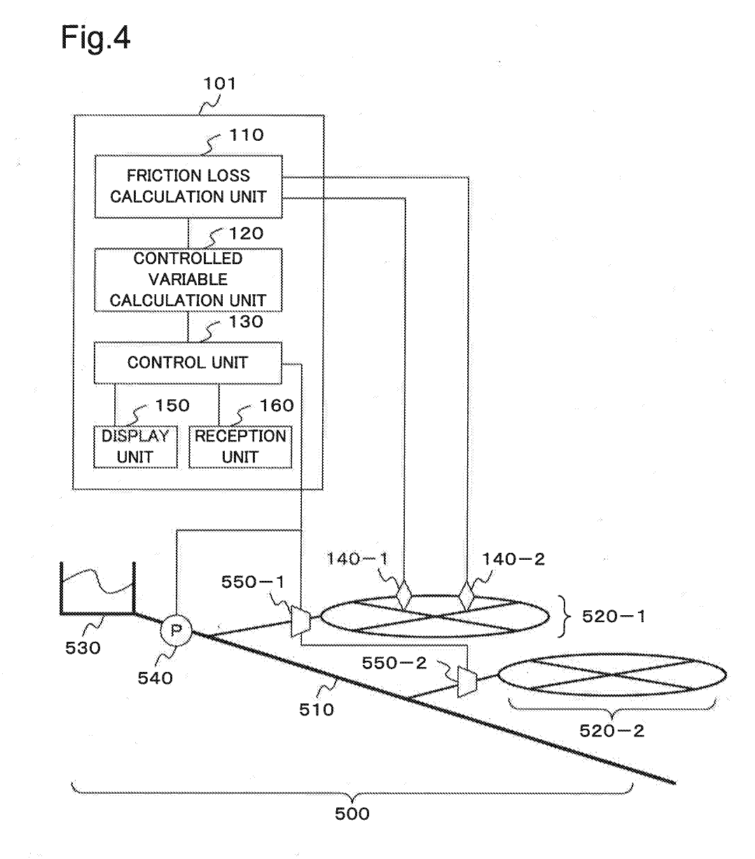

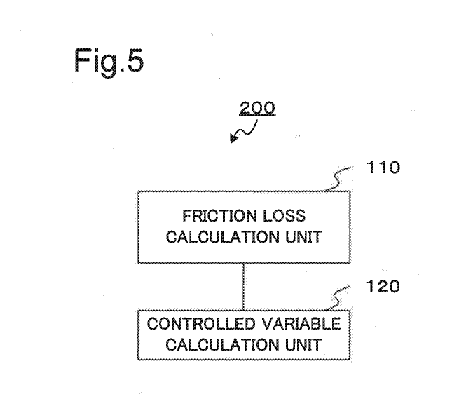

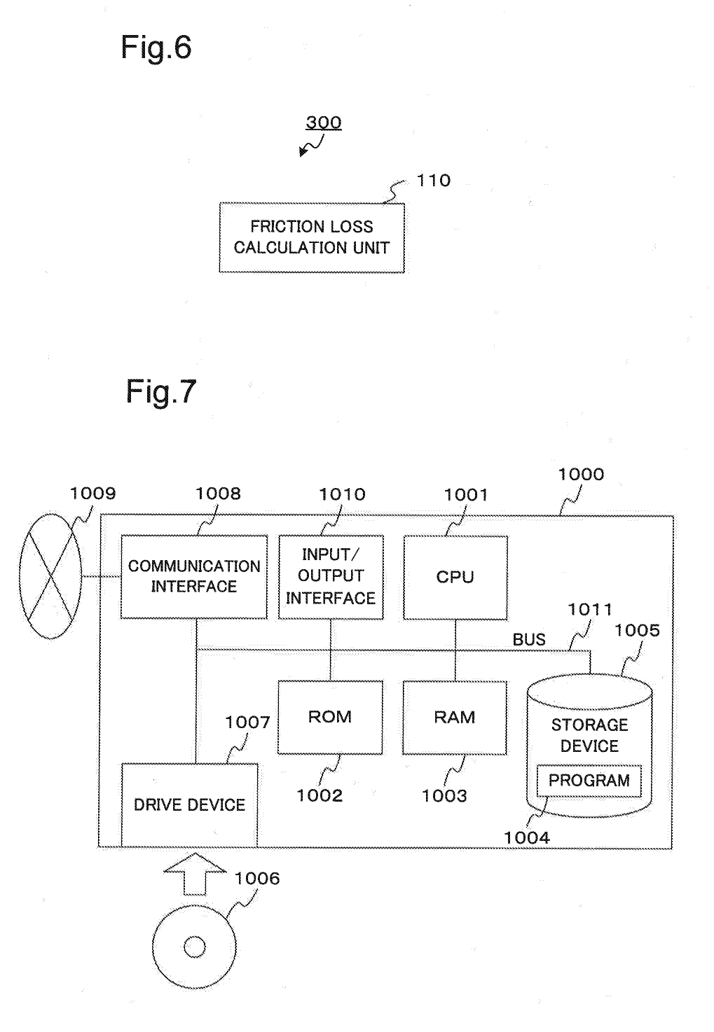

There may be a variation of the first example embodiment. FIG. 4 illustrates a configuration of a control device according to a variation of the first example embodiment of the invention. FIG. 5 illustrates a configuration of a controlled variable calculation device according to the variation of the first example embodiment of the invention. FIG. 6 illustrates a configuration of a friction loss calculation device according to the variation of the first example embodiment of the invention.

As illustrated in FIG. 4, a control device 101 according to this variation includes a friction loss calculation unit 110, a controlled variable calculation unit 120, a control unit 130, and a display unit 150. The display unit 150 displays a controlled variable of a pump 540 or a valve 550 or the like. The control device 101 may include a reception unit 160. The reception unit 160 receives an input from a user of the control device 101. In other words, the control device 101 according to this variation differs from the control device 100 according to the first example embodiment in that the control device 101 includes a display unit 150 and a reception unit 160.

In this variation, the display unit 150 is embodied by a display or the like. The display unit 150 may be directly connected to the control unit 130 or connected thereto via a communication network (not illustrated). Similarly, when the reception unit 160 is arranged, the reception unit 160 may be directly connected to the control unit 130 or connected thereto via a communication network (not illustrated).

In this variation, the display unit 150 displays the controlled variable determined by the controlled variable calculation unit 120 regarding the pump 540 or valve 550 or the like. When a plurality of pumps 540 or valves 550 are arranged in a pipeline network 500, the display unit 150 may display a controlled variable of some or all of the plurality of pumps 540 or valves 550.

The display unit 150 may display, in addition to a controlled variable, information used to ask a user or the like of the control device 101 whether to control the pump 540 or valve 550 based on the controlled variable determined by the controlled variable calculation unit 120.

Further, the display unit 150 may display information used for determining a controlled variable. For example, the display unit 150 may display information regarding the pressure determined by a pressure sensor 140 or the relationship between the pressure and the flow rate at some points of the pipeline network 500 determined by the friction loss calculation unit 110.

The reception unit 160 is embodied, for example, by a keyboard or a switch or the like. The reception unit 160 may be embodied by a touch panel integral with the display unit 150 or the like. When, for example, the aforementioned information is displayed, the reception unit 160 receives an instruction to the control device 101. When the reception unit 160 has received an instruction to perform control that is based on the aforementioned controlled variable, the control unit 130 performs control of the pump 540 or valve 550, based on the controlled variable determined by the controlled variable calculation unit 120.

When the reception unit 160 has received an instruction not to perform control that is based on the aforementioned controlled variable, the control unit 130 does not perform control that is based on the controlled variable determined by the controlled variable calculation unit 120. The control unit 130 maintains, for example, opening of the pump 540 or the number of operating valves 550 assumed when the instruction is received.

In addition, the reception unit 160 may receive an instruction to change the controlled variable determined by the controlled variable calculation unit 120. In this case, the controlled variable calculation unit 120 may determine a new controlled variable of the pump 540 or valve 550. The control unit 130 may control the pump 540 or valve 550, based on the controlled variable determined anew. In this case, the reception unit 160 may also receive a new target value regarding the pipeline network 500. When the reception unit 160 has received the new target value, the controlled variable calculation unit 120 may determine a new control value of the pump 540 or valve 550 by using the target value. The reception unit 160 may receive information regarding a controlled variable in addition to an instruction to change the controlled variable determined by the controlled variable calculation unit 120. In this case, the control unit 130 controls the pump 540 or valve 550, based on the control volume received.

Note that, when a plurality of pumps 540 or valves 550 are to be controlled, the reception unit 160 may receive an instruction to perform or not to perform control of a pump 540 or a valve 550, based on the controlled variable determined by the controlled variable calculation unit 120. In this case, the reception unit 160 may collectively receive instructions to perform or not to perform control, based on the controlled variable determined by the controlled variable calculation unit 120. Further, the reception unit 160 may receive an instruction regarding a timing or intervals at which a component of the control device 101 calculates a controlled variable or performs control.

In other words, the control device 101 according to this variation is capable of controlling the pump 540 or valve 550, based on not only the controlled variable determined by the controlled variable calculation unit 120 but also an instruction from a user. As a result, the control device 101 according to this example embodiment is capable of proper operation depending on the status of the pipeline network 500.

A component of the control device 101 may constitute a controlled variable calculation device 200 that determines a controlled variable of the pump 540 or valve 550 or the like in the pipeline network 500. The controlled variable calculation device 200 includes a friction loss calculation unit 110 and a controlled variable calculation unit 120.

Further, a component of the control device 101 may constitute a friction loss calculation device 300 that determines a friction loss of piping that constitutes the pipeline network 500. The friction loss calculation device 300 includes a friction loss calculation unit 110.

While the invention has been described referring to an example embodiment, the invention is not limited to the aforementioned example embodiment. Various changes readily understood by a person skilled in the art may be made to a configuration or a detail of the invention within the scope of the invention. Configurations according to an example embodiment may be combined with each other without departing from the scope of the invention.

The present application claims priority based on Japanese Patent Application No. 2016-30138, filed on Feb. 19, 2016, the entire disclosure of which is incorporated herein.

A part or a whole of the invention may be described under, but not limited to, the following supplementary notes.

(Supplementary Note 1)

A control device comprising:

friction loss calculation means for determining, based on a pressure of a fluid in piping, a friction loss of the pressure;

controlled variable calculation means for determining, based on the friction loss, a controlled variable of a pump or a valve that controls the distribution of water in the piping; and

control means for controlling the pump or the valve, based on the controlled variable.

(Supplementary Note 2)

The control device according to Supplementary Note 1, wherein

the friction loss calculation means determines the friction loss, based on a transient change in the pressure.

(Supplementary Note 3)

The control device according to Supplementary Note 2, wherein

the friction loss calculation means determines the friction loss, based on a transient change in the pressure determined at two points of the piping.

(Supplementary Note 4)

The control device according to Supplementary Note 3, wherein

the friction loss calculation means determines the friction loss, based on a friction coefficient determined by using the transient change in the pressure.

(Supplementary Note 5)

The control device according to Supplementary Note 4, wherein

the friction loss calculation means constructs, based on the friction loss, a piping model that represents a friction loss of the piping and wherein

the controlled variable calculation means determines the controlled variable, based on the piping model.

(Supplementary Note 6)

The control device according to any one of Supplementary Notes 1 through 5, comprising display means for displaying information regarding the controlled variable or whether to change the controlled variable.

(Supplementary Note 7)

The control device according to any one of Supplementary Notes 1 through 6, comprising reception means for receiving an instruction regarding control of the pump or the valve, wherein

the control means controls, when the reception means has received an instruction to change the controlled variable, the pump or the valve, based on the controlled variable calculated by the controlled variable calculation means.

(Supplementary Note 8)

A control system comprising:

pressure acquisition means for acquiring a pressure in the piping at a plurality of points of the piping; and

the control device according to any one of claims 1 through 7 for determining a controlled variable of the pump or the valve by using the pressure and controlling the pump or the valve.

(Supplementary Note 9)

A controlled variable calculation device comprising:

friction loss calculation means for determining, based on the pressure of a fluid in piping, a friction loss of the pressure; and

controlled variable calculation means for determining, based on the friction loss, a controlled variable of a pump or a valve that controls the distribution of water.

(Supplementary Note 10)

A friction loss calculation device comprising friction loss calculation means for determining, based on a pressure of a fluid in piping, a friction loss of piping.

(Supplementary Note 11)

A control method for determining, based on a pressure of a fluid in piping, a friction loss of the pressure,

determining, based on the friction loss, a controlled variable of a pump or a valve that controls the distribution of water in the piping, and

controlling the pump or the valve, based on the controlled variable.

(Supplementary Note 12)

A computer-readable recording medium storing a program for executing on a computer:

processing to determine, based on a pressure of a fluid in piping, a friction loss of the pressure;

processing to determine, based on the friction loss, a controlled variable of a pump or a valve that controls the distribution of water in the piping; and

processing to control the pump or the valve, based on the controlled variable.

### REFERENCE SIGNS LIST

100 Control device
110 Friction loss calculation unit
120 Controlled variable calculation unit
130 Control unit
150 Display unit
140 Pressure sensor
150 Display unit
160 Reception unit
500 Pipeline network
510 Water main
520 Water distribution block
530 Water purification plant
540 Pump
550 Valve
1000 Information processing device
1001 CPU
1002 ROM
1003 RAM
1004 Program
1005 Storage device
1006 Recording medium
1007 Drive device
1008 Communication interface
1009 Communication network
1010 Input/Output interface
1011 Bus

What is claimed is:

1. A control device comprising:
a memory; and
a processor coupled to the memory; the processor configured to run a program loaded into the memory to execute;
determining, based on a pressure of a fluid in piping, a friction loss of the pressure;
determining, based on the friction loss, a controlled variable of a pump or a valve that controls the distribution of water in the piping; and
controlling the pump or the valve, based on the controlled variable.

2. The control device according to claim 1, wherein
the processor determines the friction loss, based on a transient change in the pressure.

3. The control device according to claim 2, wherein
the processor determines the friction loss, based on a transient change in the pressure determined at two points of the piping.

4. The control device according to claim 3, wherein
the processor determines the friction loss, based on a friction coefficient determined by using the transient change in the pressure.

5. The control device according to claim 4, wherein
the processor constructs, based on the friction loss, a piping model that represents a friction loss of the piping and wherein
the processor determines the controlled variable, based on the piping model.

6. The control device according to claim 1, the processor further executes displaying information regarding the controlled variable or whether to change the controlled variable.

7. The control device according to claim 1, the processor further executes receiving an instruction regarding control of the pump or the valve, wherein
the processor controls, when receiving an instruction to change the controlled variable, the pump or the valve, based on the controlled variable calculated.

8-10. (canceled)

11. A control method for determining, based on a pressure of a fluid in piping, a friction loss of the pressure,
determining, based on the friction loss, a controlled variable of a pump or a valve that controls the distribution of water in the piping, and controlling the pump or the valve, based on the controlled variable.

12. A non-transitory computer-readable recording medium storing a program for executing on a computer:
processing to determine, based on a pressure of a fluid in piping, a friction loss of the pressure;
processing to determine, based on the friction loss, a controlled variable of a pump or a valve that controls the distribution of water in the piping; and
processing to control the pump or the valve, based on the controlled variable.
